(19) United States
(12) Patent Application Publication
(10) Pub. No.: US 2026/0110284 A1
(43) Pub. Date: Apr. 23, 2026

(54) FUEL INJECTOR NOZZLE, FUEL INJECTOR, INTERNAL COMBUSTION ENGINE, AND VEHICLE

(71) Applicant: SCANIA CV AB, Södertälje (SE)

(72) Inventor: Dennis Konstanzer, Spånga (SE)

(73) Assignee: SCANIA CV AB, Södertälje (SE)

(21) Appl. No.: 19/113,324

(22) PCT Filed: Sep. 6, 2023
(86) PCT No.: PCT/SE2023/050879

§ 371 Date: Mar. 19, 2025

(30) Foreign Application Priority Data
Sep. 20, 2022 (SE) 2251086-1

(51) Int. Cl. F02M 61/18

(52) U.S. Cl. CPC F02M 61/1833; F02M 61/184; F02M 61/1846

(57) ABSTRACT

A fuel injector nozzle (9) is disclosed. The nozzle (9) comprises a nozzle tip (9′) comprising an inner surface (39) and an outer surface (41). The nozzle (9) further comprises a number of fuel injection holes (11) each forming an inlet opening (31) at the inner surface (39) and an outlet opening (32) at the outer surface (41). At least one fuel injection hole (11) has a geometrical centre line (c1) being curved along at least a first portion (p1) of the at least one fuel injection hole (11). The radius of curvature (r1) of the geometrical centre line (c1) increases as seen in a direction (d1′) from the inlet opening (31) towards the outlet opening (32). The radius of curvature (r1) increases continuously along the full first portion (p1) of the at least one fuel injection hole (11) as seen in the direction (d1′) from the inlet opening (31) towards the outlet opening (32). A fuel injector (1), an internal combustion engine (40), and a vehicle (2) are also disclosed.

### TECHNICAL FIELD

The present disclosure relates to a fuel injector nozzle configured to inject fuel into a combustion chamber of an internal combustion engine. The present disclosure further relates to a fuel injector, an internal combustion engine comprising a fuel injector, and a vehicle comprising an internal combustion engine.

### BACKGROUND

Internal combustion engines, such as four-stroke internal combustion engines, comprise one or more cylinders and a piston arranged in each cylinder. The pistons are connected to a crankshaft of the engine and are arranged to reciprocate within the cylinders upon rotation of the crankshaft. The engine usually further comprises one or more inlet valves and outlet valves as well as one or more fuel supply arrangements. The one or more inlet valves and outlet valves are controlled by a respective valve control arrangement usually comprising one or more camshafts rotatably connected to a crankshaft of the engine, via a belt, chain, gears, or similar. A four-stroke internal combustion engine completes four separate strokes while turning a crankshaft. A stroke refers to the full travel of the piston along the cylinder, in either direction.

The strokes are completed in the following order, inlet stroke, compression stroke, expansion stroke and exhaust stroke. During operation of a conventional four-stroke internal combustion engine, the inlet valve control arrangement controls inlet valves of a cylinder to an open state during the inlet stroke of a piston within the cylinder, to allow air, or a mixture of air and fuel, to enter the cylinder. During the compression stroke, all valves should be closed to allow compression of the air, or the mixture of the air and fuel, in the cylinder. If the engine is in a power producing state, fuel in the cylinder is ignited, usually towards the end of the compression stroke, for example by a spark plug or by compression heat in the cylinder.

The combustion of fuel within the cylinder significantly increases pressure and temperature in the cylinder. The combustion of the fuel usually continues into a significant portion of the subsequent expansion stroke. The increased pressure and temperature in the cylinder obtained by the combustion is partially converted into mechanical work supplied to the crank shaft during the expansion stroke. The expansion stroke is also usually referred to as the combustion stroke, since usually, most of the combustion takes place during the expansion stroke. In the subsequent exhaust stroke, the exhaust valve control arrangement controls exhaust valves of the cylinder to an open state to allow exhaust gases to be expelled out of the cylinder into an exhaust system of the combustion engine.

A fuel injector is a device used for supplying fuel to a combustion chamber of an internal combustion engine. Compression ignition engines, such as diesel engines, and some spark ignition engines, such as Otto engines, use a fuel injector configured to supply fuel into a combustion chamber. Gasoline engines having a fuel injector for supplying fuel into a combustion chamber are usually referred to as gasoline direct injection engines. In diesel engines, the injected fuel is ignited by compression heat, or by a glow plug. In Otto engines, the injected fuel is ignited by a spark of a spark plug.

Other types of fuel injectors exit, such as fuel injectors configured to inject fuel into an inlet manifold of a gasoline engine. However, these types of fuel injectors are essentially technically different from fuel injectors configured to inject fuel into a combustion chamber and normally operate with significantly lower fuel injection pressures than fuel injectors configured to inject fuel into a combustion chamber. Moreover, a fuel injector configured to inject fuel into a combustion chamber of an engine is associated with totally different design challenges than a fuel injector configured to inject fuel into an inlet manifold partly because of the fact that a fuel injector configured to inject fuel into a combustion chamber is subjected to significantly higher peak temperatures and pressures than a fuel injector configured to inject fuel into an inlet manifold of an engine.

Fuel injectors configured to inject fuel into a combustion chamber of an internal combustion engine typically comprise a nozzle with a nozzle tip protruding into the combustion chamber. The nozzle tip typically comprises a valve seat an inner surface of the nozzle tip, wherein a so-called sac volume is formed between an outer surface of a needle tip of a needle and an inner surface of the nozzle tip of the nozzle. Moreover, these types of fuel injectors typically comprise a number of fuel injection holes each forming an inlet opening at the inner surface of the nozzle tip and an outlet opening at the outer surface of the nozzle tip. The needle is typically moved in a direction to and from the nozzle to interact with the valve seat of the nozzle to open and close a fluid connection between a fuel cavity of the fuel injector and the sac volume. As mentioned, the nozzle tip is typically configured to protrude into the combustion chamber and thus comprises an outer surface configured to adjoin the combustion chamber.

The fuel injector nozzle is a vital part for the fuel economy and emission control of a combustion engine. Development of fuel injectors have led to high injection pressures of the fuel which is advantageous for reducing exhaust emissions from the engine, such as formation of soot. In addition, fuel injectors have been developed capable of performing several successive injections during a combustion cycle, which puts demands on the design of the fuel injector. The different injection events during a combustion cycle can include a pilot injection, a main injection, and a post injection. Moreover, many fuel injectors can be controlled to perform several successive pilot injections and post injections in one combustion cycle.

The main injection event needs to develop fast and are large in volume compared to the pilot injections. Moreover, the size of the main injection, i.e., the amount of fuel injected during the main injection, substantially follows the output power of the engine. Therefore, at least on some occasions, a fuel injector must be able to inject large quantities of fuel into the combustion chamber, which, in combination with high injection pressures, puts demand on the design of the fuel injector nozzle.

Generally, it is wanted to design a fuel injector nozzle such that a small sac volume is obtained. One reason for this is that fuel is trapped inside the sac volume when the fluid connection between the sac volume and the fuel cavity of the fuel injector is closed by the needle. The fuel trapped in the sac volume normally cannot burn because of a lack of oxygen in the sac volume. However, the fuel inside the sac volume is heated by the combustion of fuel in the surrounding combustion chamber. As a result, the fuel is heated without the presence of oxygen which normally results in formation of soot particles. Such heating of fuel inside the sac volume can thus increase the emissions of soot/smoke and can result in a slight increase in the fuel consumption of the engine.

Moreover, in many engines, it is an advantage if the fuel injector nozzle can be provided with a large number of fuel injection holes. A large number of fuel injection holes leads to a large number of flame fronts in the combustion chamber which can improve fuel efficiency of the engine because a larger proportion of the total combustion can occur early in the expansion stroke. An early combustion can improve fuel efficiency because the pressure increase resulting from the combustion can produce work in a larger proportion of the expansion stroke of the piston when the fuel is burning at an early stage of the expansion stroke as compared to when the fuel is burnt at a later stage of the expansion stroke.

However, as understood from the above, the desire for a small sac volume and/or a large number of fuel injection holes are conflicting requirements for the simple fact that a large number of inlet openings normally cannot be fitted on a small delimiting surface of a small sac volume. Moreover, usually, inlet openings of the fuel injection holes cannot be placed too close to each other. This is because too small distances between adjacent inlet openings of the fuel injection holes can cause hole blending due to erosion of the material of the nozzle. Hole blending due to erosion can cause malfunction of the nozzle.

Another problem associated with fuel injector nozzles is cavitation which is especially prone to occur around edges of inlet openings of the fuel injector nozzle at the inner surface of the nozzle tip of the nozzle. The cavitation may cause erosion of the material of the nozzle and may cause hole blending with subsequent potential malfunction of the nozzle, as mentioned above.

Since a fuel injector and a fuel injector nozzle each is a vital part for the function of an internal combustion engine, it is desirable to obtain durable and reliable fuel injectors and fuel injector nozzles.

A further problem associated with fuel injector nozzles is the flow characteristics through the number of fuel injection holes of the nozzle. That is, it is an advantage if the nozzle can be designed such that advantageous flow characteristics of fuel is obtained through the number of fuel injection holes to thereby optimize combustion.

### SUMMARY

It is an object of the present invention to overcome, or at least alleviate, at least some of the above-mentioned problems and drawbacks.

According to a first aspect of the invention, the object is achieved by a fuel injector nozzle configured to inject fuel into a combustion chamber of an internal combustion engine. The nozzle comprises a nozzle tip comprising an inner surface configured to form a delimiting surface of a sac volume and an outer surface configured to adjoin the combustion chamber. The nozzle further comprises a valve seat arranged to interact with a needle to open and close a fluid connection between the sac volume and a fuel cavity of a fuel injector comprising the nozzle. The nozzle further comprises a number of fuel injection holes each forming an inlet opening at the inner surface of the nozzle tip and an outlet opening at the outer surface of the nozzle tip. At least one fuel injection hole of the number of fuel injection holes has a geometrical centre line being curved along at least a first portion of the at least one fuel injection hole. The radius of curvature of the geometrical centre line increases as seen in a direction from the inlet opening towards the outlet opening, wherein the radius of curvature increases continuously along the full first portion of the at least one fuel injection hole as seen in the direction from the inlet opening towards the outlet opening.

Since the at least one fuel injection hole has a geometrical centre line being curved along at least a first portion of the at least one fuel injection hole, conditions are provided for advantageous flow characteristics of fuel flowing through the at least one fuel inject injection hole.

Moreover, due to the geometrical centre line being curved along at least the first portion of the at least one fuel injection hole, conditions are provided for a reduced inflow angle at an edge of the inlet opening at the inner surface of the nozzle tip. A reduced inflow angle at the edge of the inlet opening can reduce cavitation tendencies at the edge of the inlet opening and thus also occurrences of erosion of the material around the inlet opening at the inner surface of the nozzle tip of the nozzle. Accordingly, a fuel injector nozzle is provided having conditions for improved durability and reliability.

Since the radius of curvature of the geometrical centre line increases as seen in a direction from the inlet opening towards the outlet opening conditions are provided for a further reduced inflow angle at the edge of the inlet opening. This is because a small radius of curvature of the geometrical centre line means a great curvature of the at least one fuel injection hole and since the radius of curvature of the geometrical centre line increases as seen in a direction from the inlet opening towards the outlet opening, conditions are provided for a further reduced inflow angle at the edge of the inlet opening.

Further, since the radius of curvature increases continuously along the full first portion of the at least one fuel injection hole as seen in the direction from the inlet opening towards the outlet opening conditions are provided for further advantageous flow characteristics of fuel flowing through the at least one fuel inject injection hole. Moreover, cavitation tendencies of fuel flowing through the at least one fuel injection hole can be reduced.

Accordingly, a fuel injector nozzle is provided overcoming, or at least alleviating, at least some of the above-mentioned problems and drawbacks. As a result, the above-mentioned object is achieved.

Optionally, the geometrical centre line is continuously curved along the first portion of the at least one fuel injection hole. Thereby, conditions are provided for even further advantageous flow characteristics of fuel flowing through the at least one fuel inject injection hole.

Moreover, since the geometrical centre line is continuously curved along the first portion of the at least one fuel injection hole, cavitation tendencies of fuel flowing through the at least one fuel injection hole can be reduced.

Optionally, the first portion of the at least one fuel injection hole comprises an inlet portion of the at least one fuel injection hole. Thereby, conditions are provided for even further advantageous flow characteristics of fuel flowing through the inlet portion of the at least one fuel inject injection hole. Moreover, conditions are provided for a further reduced inflow angle at the edge of the inlet opening of the at least one fuel inject injection hole. As a result, cavitation tendencies at the edge of the inlet opening can be further reduced and thus also occurrences of erosion of the material around the inlet opening at the inner surface of the nozzle tip.

Optionally, the length of the first portion of the at least one fuel injection hole constitutes at least 30%, preferably at least 60%, of the total length of the at least one fuel injection hole, measured from the inlet opening towards the outlet opening. Thereby, conditions are provided for further advantageous flow characteristics of fuel flowing through the at least one fuel inject injection hole. This is because the first portion of the at least one fuel injection hole, having the geometrical centre line being curved, constitutes a large proportion of the total length of the at least one fuel injection hole. As a further result, conditions are provided for a further reduced inflow angle at the edge of the inlet opening which can reduce cavitation tendencies at the edge of the inlet opening and thus also occurrences of erosion of the material around the inlet opening at the inner surface of the nozzle tip.

Optionally, the total length of the at least one fuel injection hole is at least 3 times greater, or is at least 4 times greater, than the diameter of the outlet opening. Thereby, conditions are provided for further advantageous flow characteristics of fuel flowing through the at least one fuel inject injection hole. This is because the at least one fuel injection hole has a significant total length as compared to the diameter of the outlet opening of the at least one fuel injection hole. As a further result, conditions are provided for a small inflow angle at the edge of the inlet opening while avoiding a too great curvature of the geometrical centre line.

Moreover, due to the significant total length as compared to the diameter of the outlet opening of the at least one fuel injection hole, conditions are provided for manufacturing the fuel injector nozzle in large numbers in a simpler and more cost-efficient manner while obtaining consistent injection performance among the number of fuel injector nozzles.

Optionally, the inlet opening is elliptical. Thereby, conditions are provided for further advantageous flow characteristics of fuel flowing into the inlet opening of the at least one fuel injection hole. Moreover, conditions are provided for a further reduced inflow angle at the edge of the inlet opening. Furthermore, since the inlet opening is elliptical, conditions are provided for an increased distance from edges of the inlet opening of the at least one fuel injection hole to edges of inlet openings of adjacent fuel injection holes. In this manner, conditions are provided for a nozzle with a small sac volume and/or a large number of fuel injection holes while avoiding hole blending due to erosion.

In addition, an increased distance from edges of the inlet opening of the at least one fuel injection hole to edges of inlet openings of adjacent fuel injection holes provides conditions for machining the edges of the at least one fuel injection hole to a greater extent in order to remove sharp edges without risking hole blending. Such machining can further prevent the formation of cavitation and thus also erosion damages of the material of the nozzle. The edges of the inlet opening of the at least one fuel injection hole may for example be machined using a hydro-erosion machining method.

Optionally, the first portion of the at least one fuel injection hole has an elliptical cross section in a plane perpendicular to a direction from the inlet opening towards the outlet opening. , conditions are provided for further advantageous flow characteristics of fuel flowing through the first portion of the at least one fuel inject injection hole. Moreover, conditions are provided for a further reduced inflow angle at the edge of the inlet opening. Furthermore, since the first portion of the at least one fuel injection hole has an elliptical cross section, conditions are provided for an increased distance from edges of the inlet opening of the at least one fuel injection hole to edges of inlet openings of adjacent fuel injection holes. In this manner, conditions are provided for a nozzle with a small sac volume and/or a large number of fuel injection holes while avoiding hole blending due to erosion.

Optionally, the eccentricity of the elliptical cross section at an inlet portion of the at least one fuel injection hole is greater than 0.3 or is greater than 0.5. Thereby, conditions are provided for further advantageous flow characteristics of fuel flowing through the inlet portion of the at least one fuel injection hole. Moreover, since the eccentricity of the elliptical cross section at an inlet portion of the at least one fuel injection hole is greater than 0.3 or is greater than 0.5, conditions are provided for an increased distance from edges of the inlet opening of the at least one fuel injection hole to edges of inlet openings of adjacent fuel injection holes. In this manner, conditions are provided for a nozzle with a small sac volume, and/or a large number of fuel injection holes, while avoiding hole blending due to erosion damages of the material of the nozzle.

In addition, an increased distance from edges of the inlet opening of the at least one fuel injection hole to edges of inlet openings of adjacent fuel injection holes provides conditions for machining the edges of the at least one fuel injection hole to a greater extent in order to remove sharp edges without risking hole blending. Such machining can further prevent the formation of cavitation and thus also erosion damages of the material of the nozzle. The edges of the inlet opening of the at least one fuel injection hole may for example be machined using a hydro-erosion machining method.

Optionally, the eccentricity of the elliptical cross section decreases as seen in a direction from the inlet opening towards the outlet opening. Thereby, conditions are provided for further advantageous flow characteristics of fuel flowing through the at least one fuel injection hole, while providing conditions for a smaller inflow angle at the edge of the inlet opening, and conditions for a small sac volume, and/or a large number of fuel injection holes, while avoiding hole blending due to erosion damages of the material of the nozzle. In addition, conditions are provided for obtaining a flow stabilizing zone towards the outlet opening of the at least one fuel injection hole.

Optionally, the eccentricity of the elliptical cross section decreases continuously along the full first portion of the at least one fuel injection hole as seen in a direction from the inlet opening towards the outlet opening. Thereby, conditions are provided for further advantageous flow characteristics of fuel flowing through the first portion of the at least one fuel injection hole, while providing conditions for a smaller inflow angle at the edge of the inlet opening, and conditions for a small sac volume, and/or a large number of fuel injection holes, while avoiding hole blending due to erosion damages of the material of the nozzle. In addition, cavitation tendencies of fuel flowing through the at least one fuel injection hole can be reduced.

Optionally, the eccentricity of the at least one fuel injection hole reaches zero at a boundary between the first portion and a second portion of the at least one fuel injection hole. Thereby, conditions are provided for further advantageous flow characteristics of fuel flowing through the first portion of the at least one fuel injection hole. Moreover, a flow stabilizing zone is provided towards the outlet opening while providing conditions for a smaller inflow angle at the edge of the inlet opening, as well as conditions for a small sac volume, and/or a large number of fuel injection holes, while avoiding hole blending due to erosion damages of the material of the nozzle.

Optionally, the valve seat is arranged to cooperate with a needle moving along a movement axis to open and close the fluid connection between the sac volume and the fuel cavity of the fuel injector comprising the nozzle, and wherein the elliptical cross section is oriented such that the major axis of the elliptical cross section is substantially parallel to a plane comprising the movement axis. Thereby, conditions are provided for further advantageous flow characteristics of fuel flowing into the inlet opening of the at least one fuel injection hole. Moreover, conditions are provided for a further reduced inflow angle at the edge of the inlet opening.

Furthermore, since the elliptical cross section is oriented such that the major axis of the elliptical cross section is substantially parallel to a plane comprising the movement axis, conditions are provided for an increased distance from edges of the inlet opening of the at least one fuel injection hole to edges of inlet openings of adjacent fuel injection holes. In this manner, conditions are provided for a nozzle with a small sac volume, and/or a large number of fuel injection holes, while avoiding hole blending due to erosion.

In addition, conditions are provided for machining the edges of the at least one fuel injection hole to a greater extent in order to remove sharp edges without risking hole blending. Such machining can further prevent the formation of cavitation and thus also erosion damages of the material of the nozzle. The edges of the inlet opening of the at least one fuel injection hole may for example be machined using a hydro-erosion machining method.

Optionally, the outlet opening is circular. Thereby, symmetrical flame structures can be obtained in a combustion chamber by the injection of fuel from the outlet opening of the at least one fuel injection hole.

Optionally, the at least one fuel injection hole has a geometrical centre line being straight along a second portion of the at least one fuel injection hole. Thereby, conditions are provided for a flow stabilizing zone towards the outlet opening of the at least one fuel injection hole while ensuring advantageous flow characteristics of fuel flowing through the first portion of the at least one fuel injection hole. Moreover, conditions are provided for a smaller inflow angle at the edge of the inlet opening, as well as conditions for a small sac volume, and/or a large number of fuel injection holes, while avoiding hole blending due to erosion damages of the material of the nozzle. Furthermore, symmetrical flame structures can be obtained in a combustion chamber by the injection of fuel from the outlet opening of the at least one fuel injection hole.

Optionally, the second portion of the at least one fuel injection hole comprises an outlet portion of the at least one fuel injection hole. Thereby, conditions are provided for a flow stabilizing zone in the outlet portion of the at least one fuel injection hole while ensuring advantageous flow characteristics of fuel flowing through the first portion of the at least one fuel injection hole, a smaller inflow angle at the edge of the inlet opening, as well as conditions for a small sac volume, and/or a large number of fuel injection holes, while avoiding hole blending due to erosion damages of the material of the nozzle. In this manner, symmetrical flame structures can be obtained in a combustion chamber by the injection of fuel from the outlet opening of the at least one fuel injection hole.

Optionally, the first portion of the at least one fuel injection hole has a greater length than the second portion of the at least one fuel injection hole. Thereby, conditions are provided for a flow stabilizing zone in the outlet portion of the at least one fuel injection hole while ensuring further advantageous flow characteristics of fuel flowing through the first portion of the at least one fuel injection hole, a smaller inflow angle at the edge of the inlet opening, as well as conditions for a small sac volume, and/or a large number of fuel injection holes, while avoiding hole blending due to erosion damages of the material of the nozzle.

Optionally, the second portion of the at least one fuel injection hole has a circular cross section in a plane perpendicular to the geometrical centre line of the second portion. Thereby, conditions are provided for a flow stabilizing zone in the second portion of the at least one fuel injection hole. Moreover, conditions are provided for symmetrical flame structures in a combustion chamber by the injection of fuel from the outlet opening of the at least one fuel injection hole.

Optionally, the inlet opening of the at least one fuel injection hole has a greater effective cross-sectional area than the outlet opening of the at least one fuel injection hole. Thereby, conditions are provided for an advantageous flow characteristics of fuel flowing through the at least one fuel injection hole as well as conditions for a smaller inflow angle at the edge of the inlet opening.

Optionally, the effective cross-sectional area of the at least one fuel injection hole decreases continuously along the full first portion of the at least one fuel injection hole. Thereby, conditions are provided for a further advantageous flow characteristics of fuel flowing through the first portion of the at least one fuel injection hole. Moreover, cavitation tendencies of fuel flowing through the at least one fuel injection hole can be reduced.

Optionally, one wall of the nozzle, which forms a delimiting surface of the at least one fuel injection hole, has a linear extension from the inlet opening to the outlet opening of the at least one fuel injection hole. Thereby, conditions are provided for a further advantageous flow characteristics of fuel flowing through the at least one fuel injection hole while providing conditions for a smaller inflow angle at an edge of the inlet opening. Moreover, cavitation tendencies of fuel flowing through the at least one fuel injection hole can be reduced. Furthermore, the at least one fuel injection hole may be provided in a simpler and more cost-effective manner.

Optionally, the at least one fuel injection hole is provided in the nozzle using a laser machining method, also referred to as laser beam machining LBM, sometimes also referred to as laser drill machining LDM.

According to a second aspect of the invention, the object is achieved by a fuel injector configured to inject fuel into a combustion chamber of an internal combustion engine, wherein the fuel injector comprises an injector body forming a fuel cavity, a needle arranged in the injector body, and a fuel injector nozzle. The fuel injector nozzle comprises a nozzle tip comprising an inner surface configured to form a delimiting surface of a sac volume and an outer surface configured to adjoin the combustion chamber. The nozzle further comprises a valve seat arranged to interact with the needle to open and close a fluid connection between the sac volume and the fuel cavity of the fuel injector. The nozzle further comprises a number of fuel injection holes each forming an inlet opening at the inner surface of the nozzle tip and an outlet opening at the outer surface of the nozzle tip. At least one fuel injection hole of the number of fuel injection holes has a geometrical centre line being curved along at least a first portion of the at least one fuel injection hole.

Since the at least one fuel injection hole has a geometrical centre line being curved along at least a first portion of the at least one fuel injection hole, conditions are provided for advantageous flow characteristics of fuel flowing through the at least one fuel inject injection hole of the fuel injector.

Moreover, due to the geometrical centre line being curved along at least the first portion of the at least one fuel injection hole, conditions are provided for a reduced inflow angle at an edge of the inlet opening at the inner surface of the nozzle tip. A reduced inflow angle at the edge of the inlet opening can reduce cavitation tendencies at the edge of the inlet opening and thus also occurrences of erosion of the material around the inlet opening at the inner surface of the nozzle tip of the fuel injector. Accordingly, a fuel injector is provided having conditions for improved durability and reliability.

Accordingly, a fuel injector is provided overcoming, or at least alleviating, at least some of the above-mentioned problems and drawbacks. As a result, the above-mentioned object is achieved.

According to a third aspect of the invention, the object is achieved by an internal combustion engine comprising a fuel injector according to some embodiments of the present disclosure, wherein the fuel injector is configured to inject fuel into a combustion chamber of the internal combustion engine. Since the internal combustion engine comprising a fuel injector according to some embodiments, an internal combustion engine is provided overcoming, or at least alleviating, at least some of the above-mentioned problems and drawbacks. As a result, the above-mentioned object is achieved.

According to a fourth aspect of the invention, the object is achieved by a vehicle comprising an internal combustion engine according to some embodiments of the present disclosure. Since the vehicle comprises an internal combustion engine according to some embodiments, a vehicle is provided overcoming, or at least alleviating, at least some of the above-mentioned problems and drawbacks. As a result, the above-mentioned object is achieved.

Further features of, and advantages with, the present invention will become apparent when studying the appended claims and the following detailed description.

### BRIEF DESCRIPTION OF THE DRAWINGS

Various aspects of the invention, including its particular features and advantages, will be readily understood from the example embodiments discussed in the following detailed description and the accompanying drawings, in which:

FIG. 1 schematically illustrates a vehicle according to some embodiments,

FIG. 2 schematically illustrates an internal combustion engine of the vehicle illustrated in FIG. 1,

FIG. 3 illustrates a cross section of a fuel injector of the internal combustion engine illustrated in FIG. 2,

FIG. 4 illustrates a cross section of a nozzle tip of a nozzle of the fuel injector illustrated in FIG. 3,

FIG. 5 schematically illustrates a fuel injection hole of the nozzle of the fuel injector illustrated in FIG. 3 and FIG. 4,

FIG. 6 schematically illustrates an outlet opening of a fuel injection hole of the nozzle explained with reference to FIG. 3-FIG. 5,

FIG. 7 schematically illustrates an inlet opening of the fuel injection hole of the nozzle explained with reference to FIG. 3-FIG. 6,

FIG. 8 illustrates an elliptical cross section of an inlet portion of the fuel injection hole of the nozzle explained with reference to FIG. 3-FIG. 7, and

FIG. 9 schematically illustrates a portion of an inner surface of the nozzle tip of the nozzle explained with reference to FIG. 3-FIG. 8.

### DETAILED DESCRIPTION

Aspects of the present invention will now be described more fully. Like numbers refer to like elements throughout. Well-known functions or constructions will not necessarily be described in detail for brevity and/or clarity.

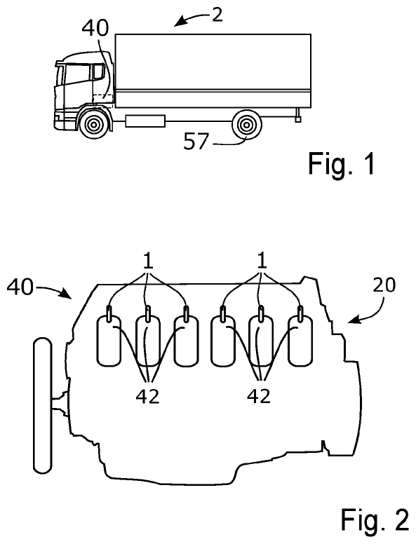

FIG. 1 schematically illustrates a vehicle 2 according to some embodiments. According to the illustrated embodiments, the vehicle 2 is a truck, i.e., a type of heavy vehicle. According to further embodiments, the vehicle 2, as referred to herein, may be another type of heavy or lighter type of manned or unmanned vehicle for land or water-based propulsion such as a lorry, a bus, a construction vehicle, a tractor, a car, a ship, a boat, or the like.

The vehicle 2 comprises an internal combustion engine 40. According to the illustrated embodiments, the internal combustion engine 40 is configured to provide motive power to the vehicle 2 via wheels 57 of the vehicle 2.

FIG. 2 schematically illustrates the internal combustion engine 40 of the vehicle 2 illustrated in FIG. 1. The internal combustion engine 40 is in some places herein referred to as the “combustion engine 40”, or simply “the engine 40”, for reasons of brevity and clarity. Below, simultaneous reference is made to FIG. 1 and FIG. 2, if not indicated otherwise.

The vehicle 2 may comprise one or more electric propulsion motors in addition to the internal combustion engine 40 for providing motive power to the vehicle 2. Thus, the vehicle 2, as referred to herein, may comprise a so-called hybrid electric powertrain comprising one or more electric propulsion motors in addition to the combustion engine 40 for providing motive power to the vehicle 2.

According to the illustrated embodiments, the internal combustion engine 40 comprises six cylinders 20 arranged in one row. The internal combustion engine 40 according to the illustrated embodiments may therefore be referred to an inline-six engine. However, according to further embodiments, the internal combustion engine 40, as referred to herein, may comprise another number of cylinders 20. Moreover, the cylinders 20 of the internal combustion engine 40 may be arranged in another configuration than in one row, such as in two or more rows.

According to embodiments herein, the internal combustion engine 40 is a four-stroke internal combustion engine. Moreover, according to the illustrated embodiments, the internal combustion engine 40 is a diesel engine, i.e., a type of compression ignition engine. The internal combustion engine 40 may thus be a compression ignition engine configured to operate on diesel or a diesel-like fuel, such as biodiesel, biomass to liquid (BTL), or gas to liquid (GTL) diesel. Diesel-like fuels, such as biodiesel, can be obtained from renewable sources such as vegetable oil which mainly comprises fatty acid methyl esters (FAME). Diesel-like fuels can be produced from many types of oils, such as rapeseed oil (rapeseed methyl ester, RME) and soybean oil (soy methyl ester, SME).

According to further embodiments, the internal combustion engine 40, as referred to herein, may be an Otto engine with a spark-ignition device, wherein the Otto engine may be configured to run on petrol, alcohol, similar volatile fuels, or combinations thereof. Alcohol, such as ethanol, can be derived from renewable biomass. According to some embodiments, the internal combustion engine 40, as referred to herein, may be arranged to power another type of device, system, or unit than a vehicle, such as for example an electric generator, a ship, a boat, or the like.

Each cylinder 20 of the internal combustion engine 40 comprises a piston connected to a crankshaft of the internal combustion engine 40, wherein the piston is configured to reciprocate in the cylinder upon rotation of the crankshaft. Combustion chambers 42 are formed between a piston top and cylinder walls of the cylinders 20 of the internal combustion engine 40.

The internal combustion engine 40 comprises a number of fuel injectors 1, wherein each fuel injector 1 is configured to inject fuel into a combustion chamber 42 the internal combustion engine 40. In other words, according to the illustrated embodiments, the internal combustion engine 40 comprises the same number of fuel injectors 1 as the number of cylinders 20. Moreover, according to the illustrated embodiments, each fuel injector 1 is configured to inject fuel directly into a combustion chamber 42 the internal combustion engine 40.

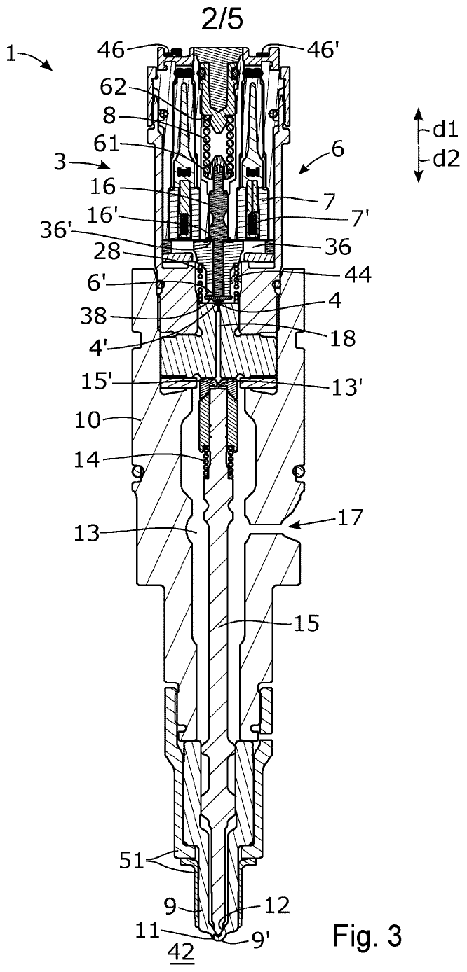

FIG. 3 illustrates a cross section of a fuel injector 1 of the internal combustion engine 40 illustrated in FIG. 2. Below, simultaneous reference is made to FIG. 1-FIG. 3, if not indicated otherwise. As explained above, the fuel injector 1 is configured to inject fuel into a combustion chamber 42 of an internal combustion engine 40, such as into a combustion chamber 42 of the internal combustion engine 40 illustrated in FIG. 1 and FIG. 2. The combustion chamber 42 is also schematically indicated in FIG. 3.

The fuel injector 1 comprises a fuel injector nozzle 9 with a nozzle tip 9′ at a distal end of the fuel injector 1. The nozzle tip 9′ is configured to protrude into a combustion chamber 42 of an internal combustion engine. As is further explained herein, the fuel injector nozzle 9 of the fuel injector 1 is configured to inject fuel directly into the combustion chamber 42. For reasons of brevity and clarity, the fuel injector nozzle 9 is in some places herein referred to as the “nozzle 9”.

The fuel injector 1 comprises an injector body 10 and a needle 15 arranged in the injector body 10. The nozzle 9 is attached to the injector body 10 via a sleeve arrangement 51. The fuel injector 1 further comprises a fuel cavity 13 formed inside the injector body 10. The fuel injector 1 comprises a fuel supply port 17 fluidly connected to the fuel cavity 13. The fuel supply port 17 is configured to be connected to a high-pressure fuel supply conduit. That is, the internal combustion engine 40 comprising the fuel injector 1 may comprise a fuel supply system configured to supply fuel at high pressure to each fuel supply port 17 of the fuel injectors 1 of the internal combustion engine 40.

The fuel supply system may be a so-called common rail system. The fuel supply system may be configured to supply fuel at a pressure of above 300 bar, or above 1 500 bar, to each fuel supply port 17 of the fuel injectors 1 of the internal combustion engine 40.

The nozzle 9 comprises a valve seat 12. As is further explained in the following, the needle 15 is configured to interact with the valve seat 12 of the nozzle 9 to open and close a fluid connection between the fuel cavity 13 and a sac volume of the fuel injector 1.

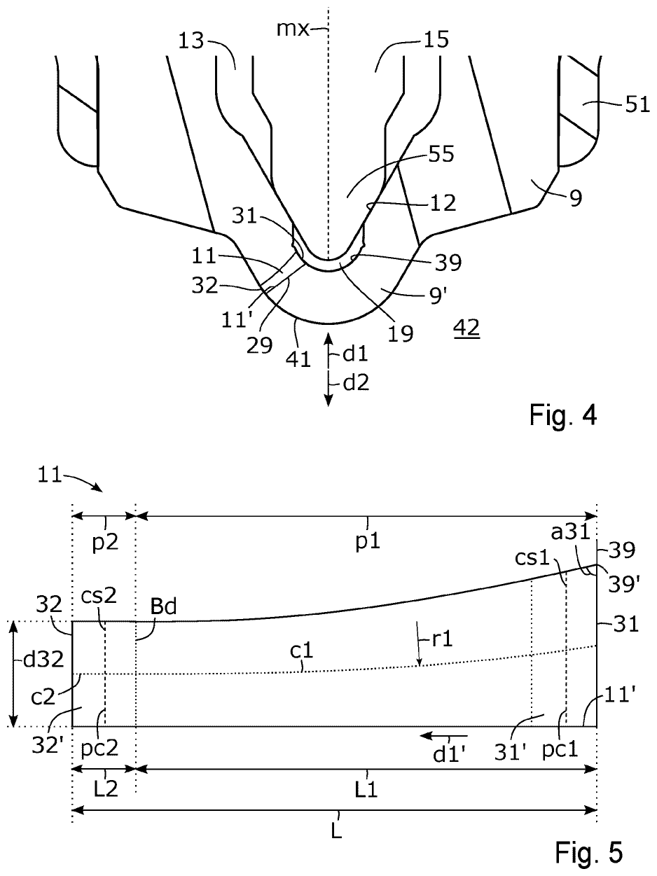

FIG. 4 illustrates a cross section of the nozzle tip 9′ of the nozzle 9 of the fuel injector 1 illustrated in FIG. 3. Moreover, in FIG. 4, a portion of the needle 15 and a portion of the sleeve arrangement 51 of the fuel injector 1 illustrated in FIG. 3 can be seen.

The nozzle tip 9′ comprises an inner surface 39 and an outer surface 41. The outer surface 41 of the nozzle tip 9′ is configured to adjoin the combustion chamber 42 and forms a delimiting surface of the combustion chamber 42 when the nozzle tip 9′ protrudes into a combustion chamber 42. In other words, the outer surface 41 of the nozzle tip 9′ is configured to face the combustion chamber 42. The combustion chamber 42 is also schematically illustrated in FIG. 4. Below, simultaneous reference is made to FIG. 1-FIG. 4, if not indicated otherwise.

The inner surface 39 of the nozzle tip 9′ is configured to face a needle tip 55 of the needle 15 and is configured to face the fuel cavity 13 of the fuel injector 1. The nozzle 9 further comprises the valve seat 12 referred to above. According to the illustrated embodiments, the valve seat 12 is a portion of the inner surface 39 of the nozzle tip 9′. Moreover, the fuel injector 1 further comprises the sac volume 19 referred to above.

The nozzle 9 comprises a number of fuel injection holes 11 each forming an inlet opening 31 at the inner surface 39 of the nozzle tip 9′ and an outlet opening 32 at the outer surface 41 of the nozzle tip 9′. The sac volume 19 is thus fluidly connected to the combustion chamber 42 via the number of fuel injection holes 11 when the fuel injector 1 is arranged in an internal combustion engine 40.

The sac volume 19 can be defined as the volume formed between the valve seat 12 and the inlet openings 31 at the inner surface 39 of the nozzle tip 9′ of the fuel injector 1. As seen in FIG. 4, the sac volume 19 is delimited by the inner surface 39 of the nozzle tip 9′ and an outer surface of the needle tip 55.

The needle tip 55 of the needle 15 is configured to interact with the valve seat 12 of the nozzle 9 to open and close a fluid connection between the fuel cavity 13 and the sac volume 19. In more detail, the needle 15 is configured to be moved along a movement axis mx in a first and a second direction d1, d2 to open and close the fluid connection between the sac volume 19 and the fuel cavity 13 of the fuel injector 1. The movement axis mx of the needle 15 coincides with a geometrical centre axis of the needle 15 as well as with a geometrical centre axis of the nozzle 9.

In FIG. 3 and FIG. 4, the first direction d1 constitutes a direction in which the needle 15 is moved away from the valve seat 12 to an opening position in which the fluid connection between the sac volume 19 and the fuel cavity 13 of the fuel injector 1 is open. Moreover, in FIG. 3 and FIG. 4, the second direction d2 constitutes a direction in which the needle 15 is moved towards the valve seat 12 of the nozzle 9 to a closing position in which the fluid connection between the sac volume 19 and the fuel cavity 13 of the fuel injector 1 is closed by an abutting contact between the needle tip 55 and the valve seat 12. In FIG. 3 and FIG. 4, the needle 15 is illustrated in the closing position.

Thus, according to the illustrated embodiments, the needle 15 is moved from the closing position towards the opening position along the first direction d1 indicated in FIG. 3 and FIG. 4 and is moved from the opening position towards the closing position along the second direction d2. As seen in FIG. 3, the fuel injector 1 comprises a spring member 14 configured to bias the needle 15 towards the closing position, i.e., the spring member 14 is configured to bias the needle 15 in the direction d2 illustrated in FIG. 3.

The fuel injector 1 comprises a control valve arrangement 3. As is further explained herein, the control valve arrangement 3 is configured to control the movement of the needle 15 between the opening and closing position by controlling a hydraulic pressure inside a control volume 13′of the fuel cavity 13.

The control valve arrangement 3 comprises a control valve 4. The control valve 4 is fluidly connected to the control volume 13′ of the fuel cavity 13 via a channel 18. The control volume 13′ of the fuel cavity 13 is delimited by a top surface 15′ of the needle 15. The control volume 13′ is fluidly connected to the remaining part of the fuel cavity 13, and thereby also to the fuel supply port 17, via a narrow flow restricting channel.

According to the illustrated embodiments, the control valve 4 comprises a ball valve configured to abut against a control valve seat 4′when the valve is closed, as is illustrated in FIG. 3.

The control valve arrangement 3 comprises an armature assembly 6 operably connected to the control valve 4 via a valve control portion 6′ of the armature assembly 6.

In more detail, the armature assembly 6 comprises an armature unit 36, a plunger 16, a spring 8, and a retainer 38. The plunger 16 is movably arranged in the armature unit 36. However, the plunger 16 comprises a plunger abutment 16′ configured to abut against an armature abutment 36′ of the armature unit 36. The plunger 16 is biased by the spring 8 in the second direction d2 towards the armature unit 36 and towards the retainer 38. According to the illustrated embodiments, the spring 8 is a coil spring. The abutting contact between the plunger abutment 16′ and the armature abutment 36′ forces the armature unit 36 in the second direction d2 towards the retainer 38.

A respective end portion of the plunger 16 and of the armature unit 36 abuts against the retainer 38. The retainer 38 is in abutting contact with the ball valve of the control valve 4.

Thus, due to these features, the spring 8 also biases the retainer 38 in the second direction d2 towards the control valve 4, and thereby also the ball valve of the control valve 4 against the control valve seat 4′. The control valve arrangement 3 comprises a second spring member 28 configured to bias the armature unit 36 in the first direction d1 away from the control valve seat 4′.

However, the biasing force of the second spring member 28 is lower than the biasing force of the spring 8. In other words, due to these features, the spring 8 is configured to force, i.e., apply a biasing force onto, the armature assembly 6 towards a closing position. As is indicated in FIG. 3, according to the illustrated embodiments, the spring 8 is configured to apply the biasing force onto the armature assembly 6 by applying a separating force between a first and second abutments 61, 62. The respective end portion of the plunger 16 and of the armature unit 36 is herein together referred to as a valve control portion 6′of the armature assembly 6.

The control valve arrangement 3 comprises an armature actuator 7. As is further explained in the following, the armature actuator 7 is configured to move the armature assembly 6 from a closing position towards an opening position to open the control valve 4 thereby causing a lift of the needle 15 from the valve seat 12 by hydraulic pressure of fuel supplied to the fuel cavity 13 via the fuel supply port 17 of the fuel injector 1.

According to the illustrated embodiments, the armature actuator 7 is configured to move the armature assembly 6 from the closing position towards an opening position by moving the armature unit 36 in the first direction d1 away from the control valve 4 when the armature actuator 7 is activated. Due to the abutting contact between the plunger abutment 16′and the armature abutment 36′, the plunger 16 is also moved in the first direction d1 away from the control valve 4 when the armature actuator 7 is activated.

As mentioned, the control volume 13′of the fuel cavity 13 is fluidly connected to the remaining part of the fuel cavity 13, and thereby also to the fuel supply port 17, via a narrow flow restricting channel. Therefore, the fuel pressure inside the control volume 13′ of the fuel cavity 13 substantially corresponds to the fuel pressure in the remaining part of the fuel cavity 13 when the control valve 4 is closed at steady state conditions. As an example, if a fuel pressure of approximately 1 500 bar is supplied to the fuel supply port 17 and the control valve 4 is closed, the fuel pressure inside the control volume 13′of the fuel cavity 13 will rise to 1 500 bar after a certain short time. This is because the control volume 13′of the fuel cavity 13 is fluidly connected to the remaining part of the fuel cavity 13 via the narrow flow restricting channel.

However, when the armature actuator 7 is activated and the valve control portion 6′ of the armature assembly 6 is moved in the first direction d1 away from the retainer 38, a movement of the ball valve of the control valve 4 is allowed in the first direction d1 away from the control valve seat 4′. Thereby, the high pressure of fuel in the channel 18, which is connected to the control valve 4, forces the ball valve 4 and the retainer 38 in the first direction d1 away from the control valve seat 4′ when the valve control portion 6′of the armature assembly 6 is moved in the first direction d1 away from the control valve seat 4′.

In this manner, the control valve 4 is opened and fuel is allowed to flow from the control volume 13′ through the channel 18, through the control valve 4, into a drainage passage 44 of the fuel injector 1 which reduces the pressure of fuel inside the control volume 13′. Due to the narrow flow restricting channel connecting the control volume 13′ to the remaining part of the fuel cavity 13, the fuel pressure inside the control volume 13′ will be lower than the fuel pressure inside the remaining part of the fuel cavity 13. As a result, the hydraulic pressure of fuel inside the fuel cavity 13 acting on the needle 15 lifts the needle 15 from the valve seat 12. In this manner, fuel is allowed to flow from the fuel cavity 13 into a combustion chamber 42 via the sac volume 19 and the number of fuel injection holes 11 of the fuel injector 1.

The feature that the needle 15 is lifted from the valve seat 12 means that the needle 15 is moved in the first direction d1 away from the valve seat 12. The spring member 14 is compressed when the needle 15 is lifted from the valve seat 12. Likewise, as understood from the above described, the spring 8 of the control valve arrangement 3 is compressed when the armature actuator 7 is moved towards the opening position.

When the armature actuator 7 is deactivated, the biasing force of the spring 8 moves the armature assembly 6 towards the closing position, i.e., moves the valve control portion 6′of the armature assembly 6 in the second direction d2 towards the retainer 38. The retainer 38 is thereby moved in the second direction d2 towards the ball valve of the control valve 4 which moves the ball valve of the control valve 4 towards the control valve seat 4′. When the ball valve of the control valve 4 reaches the control valve seat 4′and is pressed against the control valve seat 4′, the control valve 4 closes which prevents further flow of fuel from the control volume 13′ to the drainage passage 44 via the control valve 4.

In this manner, the pressure of fuel rises inside the control volume 13′which together with the biasing force of the spring member 14 forces the needle 15 to move towards the valve seat 12 which closes the fluid connection between the fuel cavity 13 and the sac volume 19 thereby preventing further flow of fuel into a combustion chamber 42 via the number of fuel injection holes 11 of the fuel injector 1.

According to the illustrated embodiments, the armature actuator 7 comprises an electromagnet 7′ configure to generate a magnetic field to move the armature assembly 6 from the closing position towards the opening position. The electromagnet 7′ comprises wire windings connected to a pair of electrical connections 46, 46′ of the fuel injector 1. According to the illustrated embodiments, the armature actuator 7 is activated by supplying an electrical current through the wire windings of the electromagnet 7′ which moves the armature unit 36 by a magnetic interaction between the wire windings of the electromagnet 7′ and metal parts of the armature unit 36.

As mentioned, the nozzle 9 of the fuel injector 1 comprises a number of fuel injection holes 11 each forming an inlet opening 31 at the inner surface 39 of the nozzle tip 9′ and an outlet opening 32 at the outer surface 41 of the nozzle tip 9′. In FIG. 3 and FIG. 4, only one fuel injection hole 11 is illustrated for reasons of brevity and clarity. However, the nozzle 9 of the fuel injector 1 may comprise more than one fuel injection hole 11 as is further explained herein.

According to embodiments herein, at least one fuel injection hole 11 of the number of fuel injection holes 11 has a geometrical centre line being curved along at least a first portion of the at least one fuel injection hole 11. Each fuel injection hole 11 of the number of fuel injection holes 11 may comprise a geometrical centre line being curved along at least a first portion of the at least one fuel injection hole 11. Moreover, each fuel injection hole 11 of the number of fuel injection holes 11 may comprise the same design and features. However, below, reference is made to one fuel injection hole 11 of the number of fuel injection holes 11, which is referred to as “the fuel injection hole 11”, for reasons of brevity and clarity.

FIG. 5 schematically illustrates the fuel injection hole 11 of the nozzle 9 of the fuel injector 1 illustrated in FIG. 3 and FIG. 4. Below, simultaneous reference is made to FIG. 1-FIG. 5, if not indicated otherwise. The fuel injection hole 11 extends from the inlet opening 31 to the outlet opening 32, wherein the inlet opening 31 is arranged at the inner surface 39 of the nozzle tip 9′ and the outlet opening 32 is arranged at the outer surface 41 of the nozzle tip 9′. The inlet opening 31 is thus configured to adjoin the sac volume 19 whereas the outlet opening 32 is configured to adjoin a combustion chamber 42 such that fuel can flow from the sac volume 19 into the inlet opening 31, through the fuel injection hole 11, and into the combustion chamber 42 via the outlet opening 32.

The fuel injection hole 11 is formed by delimiting surfaces of the nozzle tip 9′ of the nozzle 9. The inlet opening 31 may also be referred to as an inflow opening of the fuel injection hole 11 and the outlet opening 32 may also be referred to as an outflow opening of the fuel injection hole 11.

As is clearly seen in FIG. 5, the fuel injection hole 11 has a geometrical centre line c1 being curved along at least a first portion p1 of the fuel injection hole 11. The term geometrical centre line c1 as used herein means a line extending through a geometrical centre of the fuel injection hole 11. A geometrical centre is a centre at which the distances to delimiting surfaces of the fuel injection hole 11, i.e., the distances to walls of the nozzle 9 inside the fuel injection hole 11, are maximized in all radial directions.

According to the illustrated embodiments, the first portion p1 of the fuel injection hole 11 comprises the inlet opening 31 and an inlet portion 31′ of the fuel injection hole 11. Moreover, according to the illustrated embodiments, the full first portion p1 of the fuel injection hole 11 has a geometrical centre line c1 being curved. The inlet portion 31′ of the fuel injection hole 11 can be defined as the first 10% of the extension of the fuel injection hole 11, measured from the inlet opening 31 in a direction d1′ from the inlet opening 31 towards the outlet opening 32.

According to the illustrated embodiments, the length L1 of the first portion p1 of the fuel injection hole 11 constitute approximately 88% of the total length L of the fuel injection hole 11, measured in a direction d1′ from the inlet opening 31 towards the outlet opening 32.

According to further embodiments, the length L1 of the first portion p1 of the fuel injection hole 11, as referred to herein, may constitute at least 30%, or at least 60%, of the total length L of the fuel injection hole 11, measured from the inlet opening 31 towards the outlet opening 32.

Since the fuel injection hole 11 has a geometrical centre line c1 being curved along the first portion p1 of the fuel injection hole 11, conditions are provided for advantageous flow characteristics of fuel flowing through the fuel injection hole 11, as is further explained herein. Moreover, due to the geometrical centre line c1 being curved along the first portion p1 of the fuel injection hole 11, conditions are provided for a reduced inflow angle a31 at an edge 39′ of the inlet opening 31 at the inner surface 39 of the nozzle tip 9′. The inner surface 39 of the nozzle tip 9′ is indicated in FIG. 4 as well as in FIG. 5. A reduced inflow angle a31 of the edge 39′ of the inlet opening 31 can reduce cavitation tendencies of fuel flowing around the edge 39′ of the inlet opening 31 and thus also occurrences of erosion of material around the inlet opening 31 at the inner surface 39 of the nozzle tip 9′ of the nozzle 9. Thereby, a fuel injector nozzle 9 is provided having conditions for improved durability and reliability.

According to the illustrated embodiments, the geometrical centre line c1 is continuously curved along the first portion p1 of the fuel injection hole 11. Moreover, as is clearly seen in FIG. 5, the radius of curvature r1 of the geometrical centre line c1 increases as seen in a direction d1′ from the inlet opening 31 towards the outlet opening 32. The fact that the radius of curvature r1 of the geometrical centre line c1 increases as seen in a direction d1′ from the inlet opening 31 towards the outlet opening 32 means that the curvature of the geometrical centre line c1 decreases as seen in the direction d1′ from the inlet opening 31 towards the outlet opening 32.

Furthermore, as is clearly seen in FIG. 5, the radius of curvature r1 increases continuously along the full first portion p1 of the fuel injection hole 11 as seen in the direction d1′ from the inlet opening 31 towards the outlet opening 32. Due to these features, further advantageous flow characteristics is provided of fuel flowing through the fuel injection hole 11, i.e., flowing from the inlet opening 31 towards the outlet opening 32.

According to the illustrated embodiments, the fuel injection hole 11 has a geometrical centre line c2 being straight along a second portion p2 of the fuel injection hole 11. The second portion p2 of the fuel injection hole 11 comprises an outlet portion 32′ of the fuel injection hole 11. The outlet opening 32 of the fuel injection hole 11 can be defined as the last 10% of the extension of the fuel injection hole 11, measured from the inlet opening 31 in a direction d1′ from the inlet opening 31 towards the outlet opening 32.

As seen in FIG. 5, according to the illustrated embodiments, the first portion p1 of the fuel injection hole 11 has a greater length L1 than the second portion p2 of the fuel injection hole 11. Moreover, according to the illustrated embodiments, the first and second portions p1, p2 of the fuel injection hole 11 constitutes the entire fuel injection hole 11. Therefore, according to the illustrated embodiments, the length L2 of the second portion p2 of the fuel injection hole 11 constitute approximately 12% of the total length L of the fuel injection hole 11, measured in a direction d1′ from the inlet opening 31 towards the outlet opening 32.

As is further explained herein, according to the illustrated embodiments, the second portion p2 of the fuel injection hole 11 has a circular cross section cs2 in a plane Pc2 perpendicular to the geometrical centre line c2 of the second portion p2.

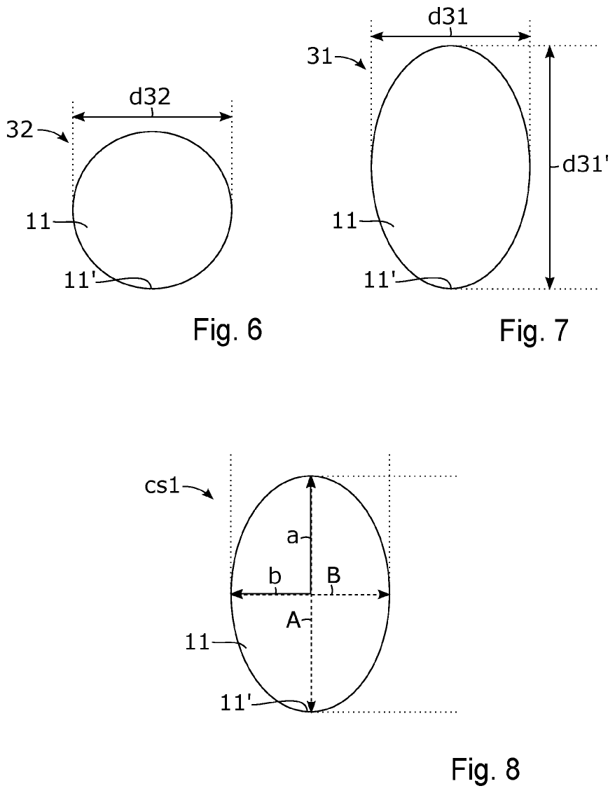

FIG. 6 schematically illustrates the outlet opening 32 of the fuel injection hole 11 of the nozzle 9 explained with reference to FIG. 3-FIG. 5. In FIG. 5, the outlet opening 32 is illustrated as viewed in a direction opposite to the direction d1′ indicated in FIG. 5.

As seen in FIG. 6, according to the illustrated embodiments, the outlet opening 32 is circular. Thereby, symmetrical flame structures can be obtained in a combustion chamber by the injection of fuel from the outlet opening 32 of the fuel injection hole 11. The feature that the outlet opening 32 is circular means that the outlet opening 32 has a circular shape in a plane perpendicular to an average outflow direction of fuel from the outlet opening 32. According to further embodiments, the outlet opening 32 may have another shape than a circular shape.

In FIG. 6, the diameter d32 of the outlet opening 32 is indicated. The diameter d32 of the outlet opening 32 is also indicated in FIG. 5. According to the illustrated embodiments, the total length L of the fuel injection hole 11, indicated in FIG. 5, is approximately 5 times greater, than the diameter d32 of the outlet opening 32. According to further embodiments, the total length L of the fuel injection hole 11 may be at least 3 times greater, or is at least 4 times greater, than the diameter d32 of the outlet opening 32.

Below, simultaneous reference is made to FIG. 1-FIG. 6, if not indicated otherwise. Since the total length L of the fuel injection hole 11 is significantly greater than the diameter d32 of the outlet opening 32, conditions are provided for further advantageous flow characteristics of fuel flowing through the fuel inject injection hole 11. Moreover, conditions are provided for a small inflow angle a31 at the edge 39′ of the inlet opening 31 while avoiding a too small radius of curvature r1 of the geometrical centre line c1 of the fuel injection hole 11.

FIG. 7 schematically illustrates the inlet opening 31 of the fuel injection hole 11 of the nozzle 9 explained with reference to FIG. 3-FIG. 6. In FIG. 7, the inlet opening 31 is illustrated as viewed in a direction coinciding with the direction d1′ indicated in FIG. 5. As seen in FIG. 7, according to the illustrated embodiments, the inlet opening 31 is elliptical. The feature that the inlet opening 31 is elliptical means that the inlet opening 31 has an elliptical shape in a plane perpendicular to an average inflow direction of fuel into the inlet opening 31. As defined herein, the eccentricity of an elliptical shape is strictly greater than zero.

According to further embodiments, the inlet opening 31 may have a shape other than circular and other than elliptical, such as a drop-shape, a semi-rectangular shape, or the like. In FIG. 7, a largest diameter d31′ of the inlet opening 31 is indicated as well as a smallest diameter d31 of the inlet opening 31. According to the illustrated embodiments, the smallest diameter d31 of the inlet opening 31 corresponds to the diameter d32 of the outlet opening 32 indicated in FIG. 6. According to further embodiments, the smallest diameter d31 of the inlet opening 31 may substantially correspond to the diameter d32 of the outlet opening 32, i.e., may differ less than 10%, or less than 7%, from the diameter d32 of the outlet opening 32.

Moreover, according to the illustrated embodiments, the smallest diameter d31 of the inlet opening 31 is approximately 65% of the largest diameter d31 of the inlet opening 31. According to further embodiments, the smallest diameter d31 of the inlet opening 31 may be within the range of 30%-99%, or may be within the range of 45%-85% of the largest diameter d31 of the inlet opening 31. Moreover, as mentioned above, the inlet opening 31 may have a shape other than an elliptical shape.

The following is explained with reference to FIG. 5. According to the illustrated embodiments, the first portion p1 of the fuel injection hole 11 has an elliptical cross section cs1 in a plane Pc1 perpendicular to a direction d1′ from the inlet opening 31 towards the outlet opening 32. FIG. 8 illustrates the elliptical cross section cs1 of the inlet portion 31′of the fuel injection hole 11 explained with reference to FIG. 3-FIG. 7. The elliptical cross section cs1 is made in a plane perpendicular to an average flow direction of fuel through the inlet portion 31′ of the fuel injection hole 11. The average flow direction of fuel through the inlet portion 31′ of the fuel injection hole 11 substantially coincides with the direction d1′ indicated in FIG. 5.

According to the illustrated embodiments, the eccentricity of the elliptical cross section cs1 at the inlet portion 31′ of the fuel injection hole 11 is approximately 0.75. According to further embodiments, the eccentricity of the elliptical cross section cs1 at an inlet portion 31′of the fuel injection hole 11 is greater than 0.3, or is greater than 0.5.

Below, simultaneous reference is made to FIG. 1-FIG. 8, if not indicated otherwise. According to the illustrated embodiments, the eccentricity of the elliptical cross section cs1 decreases as seen in a direction d1′ from the inlet opening 31 towards the outlet opening 32. Moreover, according to the illustrated embodiments, the eccentricity of the elliptical cross section cs1 decreases continuously along the full first portion p1 of the fuel injection hole 11 as seen in a direction d1′ from the inlet opening 31 towards the outlet opening 32. As is indicated in FIG. 5, the eccentricity of the fuel injection hole 11 reaches zero at a boundary Bd between the first portion p1 and a second portion p2 of the fuel injection hole 11. In this manner, advantageous flow characteristics is obtained through the fuel injection hole 11 and a smooth transition of the flow is provided causing a flow stabilizing zone in the second portion p2 of the fuel injection hole 11.

In FIG. 8, a major axis A and a minor axis B of the elliptical cross section cs1 are indicated. According to the illustrated embodiments, the eccentricity of the elliptical cross section cs1 decreases continuously along the full first portion p1 of the fuel injection hole 11 as seen in a direction d1′ from the inlet opening 31 towards the outlet opening 32 because the major axis A of the elliptical cross section cs1 decreases continuously along the full first portion p1 of the fuel injection hole 11 as seen in a direction d1′ from the inlet opening 31 towards the outlet opening 32.

The minor axis B remains constant throughout the full first portion p1 of the fuel injection hole 11 as seen in a direction d1′ from the inlet opening 31 towards the outlet opening 32. As understood from the above, the major axis A of the elliptical cross section cs1 decreases continuously along the full first portion p1 of the fuel injection hole 11 as seen in a direction d1′ from the inlet opening 31 towards the outlet opening 32 and reaches a length corresponding to the length of the minor axis B at the boundary Bd between the first and second portions p1, p2 of the fuel injection hole 11.

In FIG. 8, a semi-major axis a and a semi-minor axis b of the elliptical cross section cs1 are indicated. The length of the semi-major axis a is half the length of the major axis A. Likewise, the length of the semi-minor axis b is half the length of the minor axis B.

As indicated in FIG. 4-FIG. 8, one wall 29 of the nozzle 9, which forms a delimiting surface 11′of the fuel injection hole 11, has a linear extension from the inlet opening 31 to the outlet opening 32 of the fuel injection hole 11.

As understood from the above, according to the illustrated embodiments, the curved geometrical centre line c1 of the first portion p1 of the fuel injection hole 11 is caused by the following facts:
the first portion p1 of the fuel injection hole 11 has an elliptical cross section cs1 in a plane Pc1 perpendicular to a direction d1′ from the inlet opening 31 towards the outlet opening 32,
the eccentricity of the elliptical cross section cs1 decreases as seen in a direction d1′ from the inlet opening 31 towards the outlet opening 32, and
the eccentricity of portions of the first portion p1 of the fuel injection hole 11 is made such that a delimiting surface 11′of the fuel injection hole 11 has a linear extension throughout the first portion p1 of the fuel injection hole 11.

Moreover, as understood from the above described, according to the illustrated embodiments, the inlet opening 31 of the fuel injection hole 11 has a greater effective cross-sectional area than the outlet opening 32 of the fuel injection hole 11. Thereby, conditions are provided for an advantageous flow characteristics of fuel flowing through the fuel injection hole 11. Moreover, conditions are provided for a smaller inflow angle a31 at the edge 39′ of the inlet opening 31.

Moreover, as understood from the above described, according to the illustrated embodiments, the effective cross-sectional area of the fuel injection hole 11 decreases continuously along the full first portion p1 of the fuel injection hole 11.

As mentioned, according to some embodiments, the cross section of the first portion p1 of the fuel injection hole 11 may have a shape differing from an elliptical shape. However, also in such embodiments, the inlet opening 31 of the fuel injection hole 11 may have a greater effective cross-sectional area than the outlet opening 32 of the fuel injection hole 11. Moreover, also in such embodiments, the effective cross-sectional area of the fuel injection hole 11 may decrease continuously along the full first portion p1 of the fuel injection hole 11.

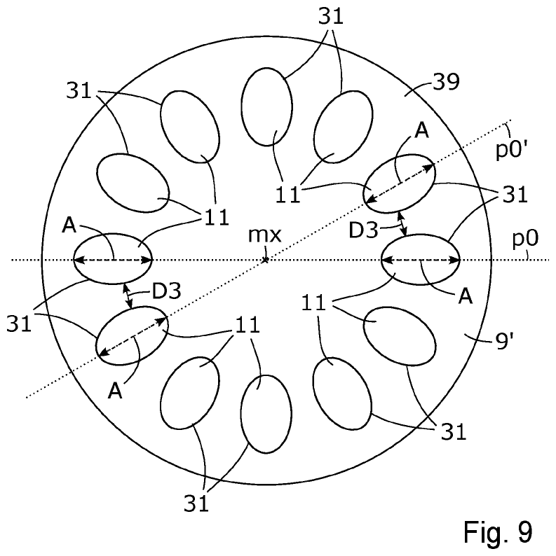

FIG. 9 schematically illustrates a portion of the inner surface 39 of the nozzle tip 9′ of the nozzle 9 explained with reference to FIG. 3-FIG. 9. In FIG. 9, the inner surface 39 is illustrated as viewed in a direction coinciding with the movement axis mx of the needle 15 illustrated in FIG. 3 and FIG. 4. Below, simultaneous reference is made to FIG. 1-FIG. 9, if not indicated otherwise.

In FIG. 9, a number of inlet openings 31 of the number of fuel injection holes 11 of the nozzle 9 can be seen. Moreover, as seen in FIG. 9, according to the illustrated embodiments, the nozzle 9 comprises twelve fuel injection holes 11. According to further embodiments, the nozzle 9 may comprise another number of fuel injection holes 11, such as a number between one and forty-five, or a number between six and thirty.

Each fuel injection hole 11 of the number of fuel injection holes 11 of the nozzle 9 may comprise the same layout, design, and advantages as the fuel injection hole 11 explained with reference to FIG. 3-FIG. 8 above.

In FIG. 9, the major axis A of the elliptical cross section cs1 of four fuel injection holes 11 of the number of fuel injection holes 11 are indicated for reasons of brevity and clarity. According to the illustrated embodiments, the elliptical cross sections cs1 of the fuel injection holes 11 are oriented such that the major axis A of each elliptical cross section cs1 is substantially parallel to a plane p0, p0′ comprising the movement axis mx of the needle 15. In other words, according to the illustrated embodiments, the fuel injection holes 11 are arranged such that the elliptical cross sections cs1 thereof are oriented such that the major axis A of each elliptical cross section cs1 is substantially parallel to a plane po, po′ comprising the movement axis mx of the needle 15. This is true for all fuel injection holes 11 of the number of fuel injection holes 11 according to the illustrated embodiments. However, only two planes p0, p0′ which comprises the movement axis mx are indicated in FIG. 9 for reasons of brevity and clarity.

Since the elliptical cross sections cs1 of the fuel injection holes 11 are oriented such that the major axis A of each elliptical cross section cs1 is substantially parallel to a plane p0, p0′ comprising the movement axis mx of the needle 15, conditions are provided for an increased distances D3 between edges of adjacent inlet openings 31 of the number of fuel injection holes 11. In this manner, conditions are provided for a nozzle 9 with a small sac volume 19 and/or a large number of fuel injection holes 11 while avoiding hole blending due to erosion damages to the material of the nozzle 9.

In addition, conditions are provided for machining the edges 39′ of the inlet openings 31 of the fuel injection hole 11 to a greater extent in order to remove sharp edges without risking hole blending. Such machining can further prevent the formation of cavitation and thus also erosion damages of the material of the nozzle 9. The edges 39′ of the inlet openings 31 of the fuel injection holes 11 may for example be machined using a hydro-erosion machining method, also referred to as abrasive fluid machining.

As mentioned, according to some embodiments, the cross section of the first portion p1 of the fuel injection holes 11 may have a shape differing from an elliptical shape and the inlet openings 31 of the fuel injection holes 11 may have a shape differing from an elliptical shape. Also in such embodiments, the fuel injection holes 11 may be arranged such that a measurement direction of the largest diameter of each cross section of the inlet portion 31′ of each fuel injection hole 11, measured in a plane perpendicular to an average flow direction through the fuel injection hole 11, is substantially parallel to a plane p0, p0′ comprising the movement axis mx of the needle 15. As understood from the above, the measurement directions of the elliptical cross sections cs1 in the illustrated example embodiments of FIG. 9 coincides with the major axis A of the illustrated elliptical inlet openings 31.

It is to be understood that the foregoing is illustrative of various example embodiments and that the invention is defined only by the appended independent claims. A person skilled in the art will realize that the example embodiments may be modified, and that different features of the example embodiments may be combined to create embodiments other than those described herein, without departing from the scope of the present invention, as defined by the appended independent claims.

Each fuel injection hole 11 of the number of fuel injection holes 11 of the nozzle 9 according to the present disclosure may be provided using a laser machining method, also referred to as laser beam machining LBM or laser drill machining LDM.

As used herein, the term “comprising” or “comprises” is open-ended, and includes one or more stated features, elements, steps, components, or functions but does not preclude the presence or addition of one or more other features, elements, steps, components, functions, or groups thereof.

The wording “substantially parallel to”, as used herein, may encompass that the angle between the objects referred to is less than 10 degrees, or is less than 7 degrees.

The wording “substantially corresponds to”, as used herein, may encompass that the aspects, objects, distances, or measurements referred to deviates less than 10% from each other.

The wording “substantially coincides with”, as used herein, may encompass that the angle between the objects referred to is less than 10 degrees, or is less than 7 degrees.

1. A fuel injector nozzle (9) configured to inject fuel into a combustion chamber (42) of an internal combustion engine (40),
the nozzle (9) comprising:
a nozzle tip (9′) comprising an inner surface (39) configured to form a delimiting surface of a sac volume (19) and an outer surface (41) configured to adjoin the combustion chamber (42),
a valve seat (12) arranged to interact with a needle (15) to open and close a fluid connection between the sac volume (19) and a fuel cavity (13) of a fuel injector (1) comprising the nozzle (9), and
a number of fuel injection holes (11) each forming an inlet opening (31) at the inner surface (39) of the nozzle tip (9′) and an outlet opening (32) at the outer surface (41) of the nozzle tip (9′),
wherein at least one fuel injection hole (11) of the number of fuel injection holes (11) has a geometrical centre line (c1) being curved along at least a first portion (pl) of the at least one fuel injection hole (11),
wherein the radius of curvature (r1) of the geometrical centre line (c1) increases as seen in a direction (d1′) from the inlet opening (31) towards the outlet opening (32), and wherein the radius of curvature (r1) increases continuously along the full first portion
(p1) of the at least one fuel injection hole (11) as seen in the direction (d1′) from the inlet opening (31) towards the outlet opening (32).

2. The nozzle (9) according to claim 1, wherein the geometrical centre line (c1) is continuously curved along the first portion (p1) of the at least one fuel injection hole (11).

3. The nozzle (9) according to claim 1 or 2, wherein the first portion (p1) of the at least one fuel injection hole (11) comprises an inlet portion (31′) of the at least one fuel injection hole (11).

4. The nozzle (9) according to claim 1, wherein the first portion (p1) has a length (L1) and the length (L1) of the first portion (pl) of the at least one fuel injection hole (11) constitutes at least 30%, preferably at least 60%, of total length (L) of the at least one fuel injection hole (11), measured from the inlet opening (31) towards the outlet opening (32).

5. The nozzle (9) according to claim 1, wherein the total length (L) of the at least one fuel injection hole (11) is at least 3 times greater, or is at least 4 times greater, than diameter (d32) of the outlet opening (32).

6. The nozzle (9) according to claim 1, wherein the inlet opening (31) is elliptical.

7. The nozzle (9) according to claim 1, wherein the first portion (p1) of the at least one fuel injection hole (11) has an elliptical cross section (cs1) in a plane (Pc1) perpendicular to a direction (d1′) from the inlet opening (31) towards the outlet opening (32).

8. The nozzle (9) according to claim 7, wherein the eccentricity of the elliptical cross section (cs1) decreases as seen in a direction (d1′) from the inlet opening (31) towards the outlet opening (32).

9. The nozzle (9) according to claim 1, wherein the inlet opening (31) of the at least one fuel injection hole (11) has a greater effective cross-sectional area than the outlet opening (32) of the at least one fuel injection hole (11).

10. The nozzle (9) according to claim 1, wherein effective cross-sectional area of the at least one fuel injection hole (11) decreases continuously along the first portion (p1) of the at least one fuel injection hole (11).

11. A fuel injector (1) configured to inject fuel into a combustion chamber (42) of an internal combustion engine (40), wherein the fuel injector (1) comprises:
an injector body (10) forming a fuel cavity (13),
a needle (15) arranged in the injector body (10), and
a fuel injector (1) nozzle (9) according to claim 1,
and wherein the needle (15) is configured to interact with a valve seat (12) of the nozzle (9) to open and close a fluid connection between the fuel cavity (13) and a sac volume (19).

12. An internal combustion engine (40) comprising a fuel injector (1) according to claim 11, wherein the fuel injector (1) is configured to inject fuel into a combustion chamber (42) of the internal combustion engine (40).

13. A vehicle (2) comprising an internal combustion engine (40) according to claim 12.
